(19) United States
(12) Patent Application Publication
(10) Pub. No.: US 2024/0330092 A1
(43) Pub. Date: Oct. 3, 2024

(54) REPORTING OF ERRORS IN PACKET PROCESSING

(71) Applicant: Intel Corporation, Santa Clara, CA (US)

(72) Inventors: Jonathan KENNY, Ballina (IE); Andrew CUNNINGHAM, Ennis (IE); Peter WALDRON, Shannon (IE); Jacqueline KEARNEY, Shannon (IE); Hugh McCARTHY, Shannon (IE)

(21) Appl. No.: 18/651,435

(22) Filed: Apr. 30, 2024

(51) Int. Cl. G06F 11/07

(52) U.S. Cl. CPC G06F 11/0772; G06F 11/0709

(57) ABSTRACT

Examples described herein relate to a network interface device that includes: a host interface; a direct memory access (DMA) circuitry; a network interface; and circuitry that is configured to: based on a configuration, detect an error in an accelerator from processing data associated with a packet received by the network interface; based on detection of the error from processing associated with the data, provide, in-band, a notification via a second packet for delivery to a computing system coupled to the network interface device, wherein the notification is indicative of telemetry associated with the error and a time stamp associated with the error; and based on non-detection of the error from processing the packet, update state associated with a flow of the packet.

### BACKGROUND

Data centers provide processing, storage, and networking resources. For example, automobiles, smart phones, laptops, tablet computers, or internet of things (IoT) devices can leverage data centers to perform data analysis, data storage, or data retrieval. Data centers are typically connected together using high speed networking devices such as network interfaces, switches, or routers.

Network interface devices can be subject to packet traffic that attempts to disrupt service, access information without authorization, or other malicious causes (e.g., denial-of-service (DOS) attacks). Malfunctioning of network interface devices can slowdown packet traversal and increase time to complete processing and storage operations.

### BRIEF DESCRIPTION OF THE DRAWINGS

FIG. 1 depicts an example system.

FIG. 2 depicts an example operation.

FIGS. 3A and 3B depict example processes.

FIG. 4 depicts an example network interface device.

FIG. 5 depicts an example network interface device.

FIG. 6 depicts an example system.

### DETAILED DESCRIPTION

Various examples herein can include a network interface device that is to detect and report errors during processing of packets. Based on a configuration, circuitry in the network interface device can detect an error in an accelerator from processing a packet and based on detection of the error from processing associated with the packet, the circuitry can provide, in-band, a notification via a second packet for delivery to a computing system coupled to the network interface device. The notification can be indicative of telemetry associated with the error and a time stamp associated with the error. Examples of telemetry that can be used to identify a root cause of an anomaly include: identification of a processing circuitry that detected the anomaly, a cause of the anomaly, a time stamp of the anomaly, a flow associated with a packet that triggered anomaly identification, and others. For example, an accelerator can include a packet processing pipeline that can detect and report errors arising from processing packets that are to be transmitted or were received by the network interface device. The accelerator can indicate a time stamp of detection of the error. In some examples, the error can be associated with a cryptographic error from processing the packet by an accelerator. In some examples, the accelerator is to perform operations such as one or more of: encryption, decryption, data compression, data decompression, data or device authentication, or trust verification.

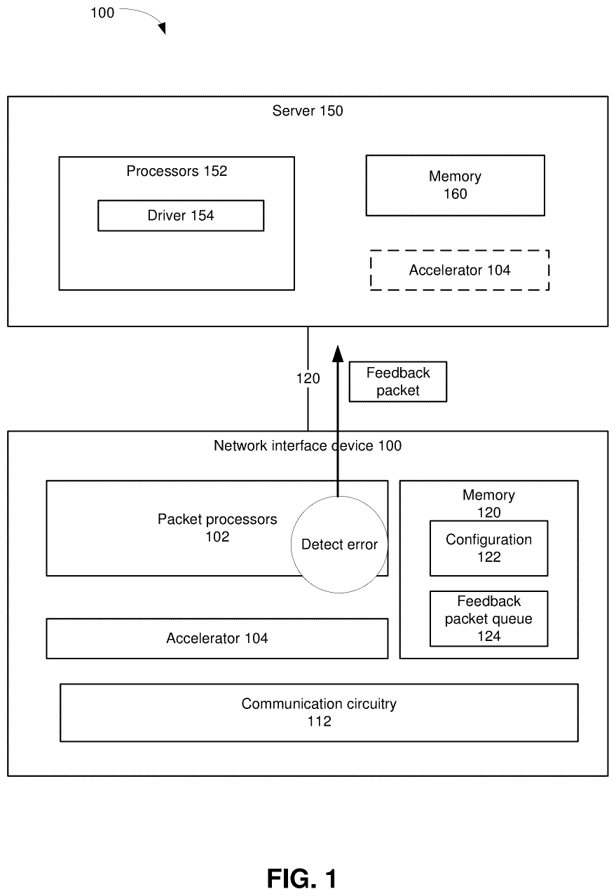

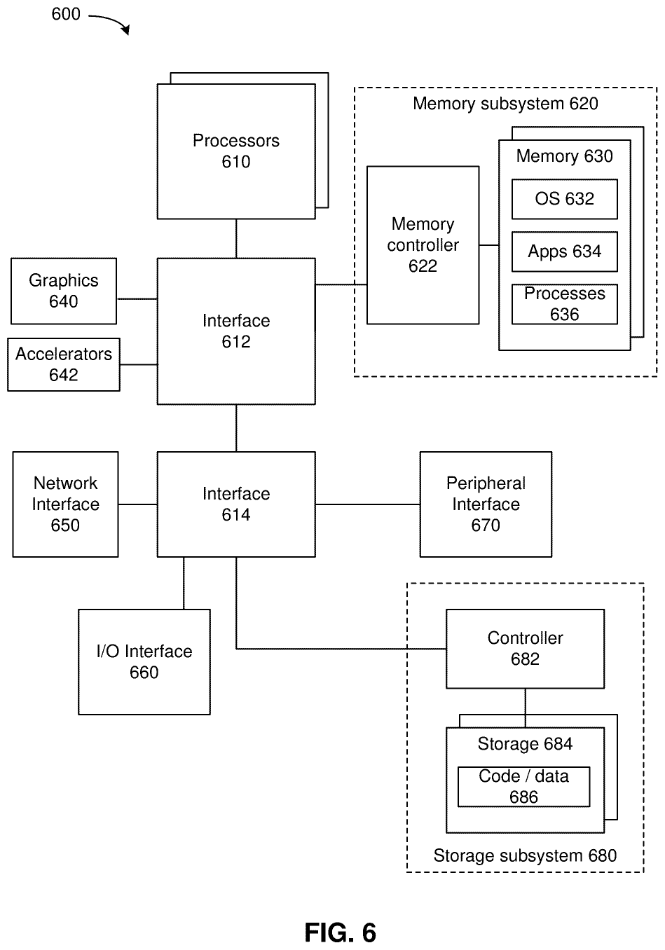

FIG. 1 depicts an example system. Server 150 can be coupled to network interface device 100 using a device interface 120 (e.g., Peripheral Component Interconnect express (PCIe), Compute Express Link (CXL), or others) or network connection, examples of which are described herein. Server 150 can include processors 152, memory 160, and other technologies described herein at least with respect to the system of FIG. 6. Processor-executed driver 154 can enable or disable packet processors 102 of network interface device 100 to detect and report telemetry and errors of packet processors 102 and/or accelerator 104, or other circuitry via one or more in-band packets to server 150, as described herein.

In some examples, network interface device 100 can include one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). A network interface device can include: one or more processors; one or more programmable packet processing pipelines; one or more accelerators; one or more application specific integrated circuits (ASICs); one or more field programmable gate arrays (FPGAs); one or more memory devices; one or more storage devices; or others.

Packet processors 102 can be configured to perform match-action on received packets to identify packet processing rules and next hops using information stored in a ternary content-addressable memory (TCAM) tables or exact match tables in some examples. Configuration of operation of packet processors 102, including its data plane, can be programmed using configuration file, OneAPI, Programming protocol independent packet processors (P4), Software for Open Networking in the Cloud (SONIC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries.

Packet processors 102 and/or accelerator 104 can perform operations such as one or more of: encryption, decryption, data compression, data decompression, data or device authentication, trust verification, or others. In some examples, packet processors 102 can be configured to detect errors or anomalies of packet processors 102 or accelerator 104 arising from processing a packet, where errors or anomalies are identified in configuration 122. Configuration 122 can be loaded into memory 160 by driver 154 or a data center administrator using an application programming interface (API), configuration file, or other communication. For example, configuration 122 can specify events described at least with respect to Table 1. Based on detection of an error with processing a packet, packet processors 102 and/or accelerator 104 can generate a feedback packet to send to server 150. A feedback packet can be identified based on a code in a packet header field or by storage into feedback packet queue 124. Processors 152 can access feedback packets of feedback packet queue by issuing descriptors for feedback packets. In some examples, the feedback packet can be copied by direct memory access (DMA) to memory 160 for access by processors 152.

For some classes of errors or anomalies, such as packets determined to be non-malicious, packet processors 102 can insert an error indication into a received and processed packet that triggered the error and forward such packet to server 150 to perform exception handling.

Based on receipt of a feedback packet, server 150 can execute an operating system, control plane software, firmware, or process or utilize an FPGA, ASIC, or other circuitry to perform a remedial action that can include one or more of: reprogram the network interface device to correctly process the packet associated with the error, disable the network interface device, remove the network interface device from service, limit a traffic rate to the accelerator, change a service level agreement (SLA) parameter associated with the accelerator to remove a packet flow allowed to use the accelerator associated with the error, remove a packet flow from being sent to the accelerator, reprogram the network interface device to drop packets of a flow associated with the error, reset the network interface device, or run diagnostics on the network interface device, or others.

A packet may be used herein to refer to various formatted collections of bits that may be sent across a network. A flow can be a sequence of packets being transferred between two endpoints, generally representing a single session using a known protocol. Accordingly, a flow can be identified by a set of defined tuples or header field values and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

Reference to flows can instead or in addition refer to tunnels (e.g., Multiprotocol Label Switching (MPLS) Label Distribution Protocol (LDP), Segment Routing over IPv6 dataplane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

Communication circuitry 112 can provide communications with other devices over a network or fabric via one or more ports. Communication circuitry 112 may be configured to use any one or more communication technology (e.g., wired or wireless communications) and associated protocols (e.g., Ethernet, InfiniBand®, Bluetooth®, Wi-Fi®, 4G LTE, 5G, Ultra Ethernet, etc.) to perform such communication. Communication circuitry 112 can include one or more network hardware resources, such as ingress queues, egress queues, crossbars, shared memory switches, media access control (MAC), physical layer interface (PHY), Ethernet port logic, and other network hardware resources.

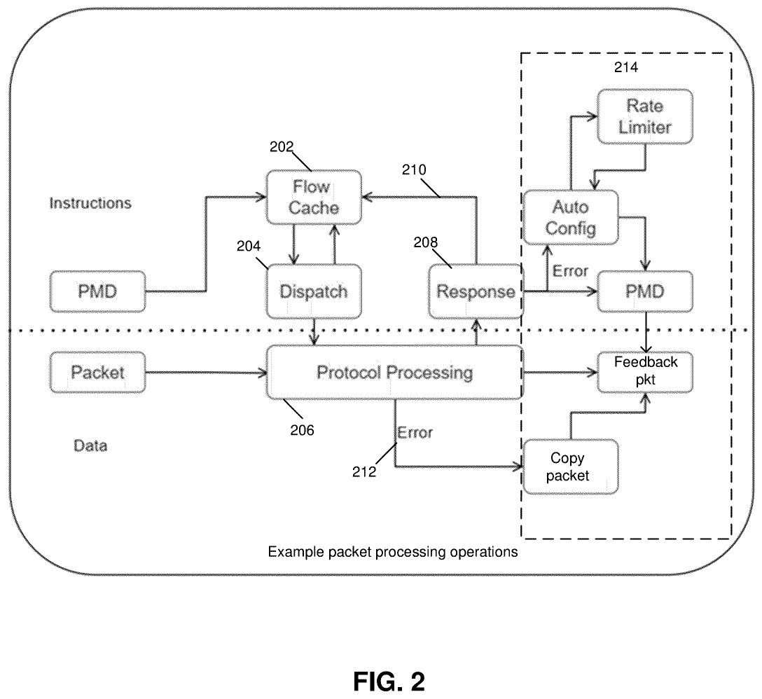

FIG. 2 depicts an example operation of a packet processing circuitry. Based on receipt of a packet, at 202, flow cache can access packet meta data (PMD) associated with the packet. For example, PMD can indicate one or more of: location of a header field of the packet in memory, rules to apply to the packet (e.g., bypass, reassembly, drop, encryption, decryption, data compression, data decompression, data or device authentication, trust verification, or others), associated Internet Protocol Security (IPSec) Security Association (SA) entry, reassembly context, etc.

At 204, PMD for the packet can be dispatched for protocol processing of the packet. At 206, packet processing circuitry can perform protocol processing to process the packet according to the rules. At 208, packet processing circuitry can issue a response that indicates error or no error. Based on no error being detected from processing the packet, at 210, packet processing circuitry can update flow cache with stateful data (e.g., packet sequence number, anti-replay window (ARW), etc.).

Based on an error being detected from processing the packet, at 212, packet processing circuitry can indicate an error in processing the packet according to the applicable rules. For example, indication of error can indicate a problem with protocol processing. At 214, based on indication of error, packet processing circuitry can: copy a portion of the packet (e.g., one or more header fields); insert the copied portion into a payload of a feedback packet; insert a portion of the associated PMD, timestamp to indicate a time when an error or anomaly occurred, and an error code into the payload of the feedback packet; and loop-back the feedback packet through the network interface device to be forwarded in-band to the connected host computer via a host interface or by transmission of the feedback packet to the host computer (e.g., cause the feedback packet to be provided to an ingress port that receives packet from a network or to an ingress queue associated with an ingress port). The feedback packet can be sent to a network queue and forwarded to control plane software executed by the host computer for analysis and debug. In some cases, a rate at which feedback packets are forwarded to the connected host computer can be rate limited according to a configuration from an orchestrator or data center administrator to throttle a number of error messages to reduce contribution to congestion. Various examples of detected errors and error messages are described herein.

Table 1 shows examples of feedback packet error code values and remedial actions.

TABLE 1

| Name | Example Description |
|---|---|
| CRYPTO_SUCCESS | Successfully encrypted or decrypted by a cryptographic |
| | accelerator and to be sent to destination. |
| | Remediation: No action taken |
| ARW_CHK_FAIL | Packet sequence number failed anti-replay window |
| | (ARW) check. |
| | Remediation: Signal out of order network, fix network |
| | configuration, or delete packet flow. |
| AUTH_CHK_FAIL | Packet failed authentication |
| | Remediation: Signal unaligned Extended Sequence |
| | Number (ESN) between transmitter and receiver, signal |
| | spoofing attack, update access control lists (ACLs) applied |
| | by protocol processing to filter packet flow to drop packets |
| | of the packet flow, or delete packet flow. |
| SOFT_AGING_THRESHOLD_CROSSED | Soft aging enabled and soft aging threshold crossed for SA |
| | entry. |
| | Remediation: Flow nearing end of life, notify control |
| | plane to delete flow. |
| HARD_AGING_THRESHOLD_CROSSED | Hard aging enabled and hard aging threshold crossed for |
| | SA entry. |
| | Remediation: Flow reached end of life, notify control |
| | plane to delete flow. |
| BAD_PKT | Protocol processing of packet failed. Bad packet |
| | detected. Packet failed protocol processing from possible |
| | malicious attack. |
| | Remediation: Update ACLs applied by protocol |
| | processing to drop packets of packet flow, or delete packet |
| | flow. |
| SEQ_NUM_ROLLOVER | SA Entry Sequence number rollover detected. (e.g., egress |
| | IPSec full termination flows). |
| | Remediation: Flow reached end of life, notify control |
| | plane to delete flow. |
| INVALID_SA_INDEX | Invalid SA entry offload request. Invalid flow in use. |
| | Remediation: Flush pipeline of packets of invalid flow. |
| SOFT_ICV_THRESHOLD_CROSSED | Soft failure threshold crossed by packets encoded using |
| | Datagram Transport Layer Security (DTLS). Flow |
| | nearing end of life for authentication. |
| | Remediation: Notify control plane to delete flow. |
| HARD_ICV_THRESHOLD_CROSSED | Hard failure threshold crossed by packets encoded using |
| | Datagram Transport Layer Security (DTLS). Flow |
| | nearing end of life for authentication. |
| | Remediation: Flow reached end of life for auth failures, |
| | notify control plane to delete flow. |
| Packet processing pipeline error | Error in packet processing pipeline |
| | Remediation: Reset device or reconfigure pipeline to |
| | process particular packet type. |
| Improper fragment size | Fragment size or checksum error. The fragment size is <32 |
| | bytes or >9728 bytes. |
| | Remediation: Maximum transmission unit (MTU) size |
| | exceeded, signal transmitters to adjust MTU size to be |
| | larger or smaller. |
| Input Checksum Error | IPv4 and UDP checksum errors. |
| | Remediation: Signal transmitter that unsupported |
| | checksums are in use. |
| Congestion Drop | Packet at input queue head dropped |
| | Remediation: Resource congested, diagnose which IP |
| | addresses are causing issues and add them to the ACLs to |
| | drop the packets. |
| Memory error | IP Fragment targeting an invalid paged memory address |
| | translation (PMAT) page. |
| | Remediation: Memory page fault, update backing memory |
| | page, discard failing fragments hitting the PMAT table, |
| | send configuration packet to close IP tracker table, flush |
| | stored fragments and avoid setting new connections, drop |
| | input fragments with the same syndrome, start PMAT |
| | reconfiguration. |
| Unknown connection flag | Fragment without a new connection flag, while the |
| | connection is in closed or idle state. |
| | Remediation: Send packet to control plane software to |
| | cause packet reassembly. |
| Fragment length | Packet is too small. IPv4/v6 have individual minimum |
| | length. |
| | Remediation: Diagnose which IP addresses are causing |
| | issues and add them to the ACLs to drop. |

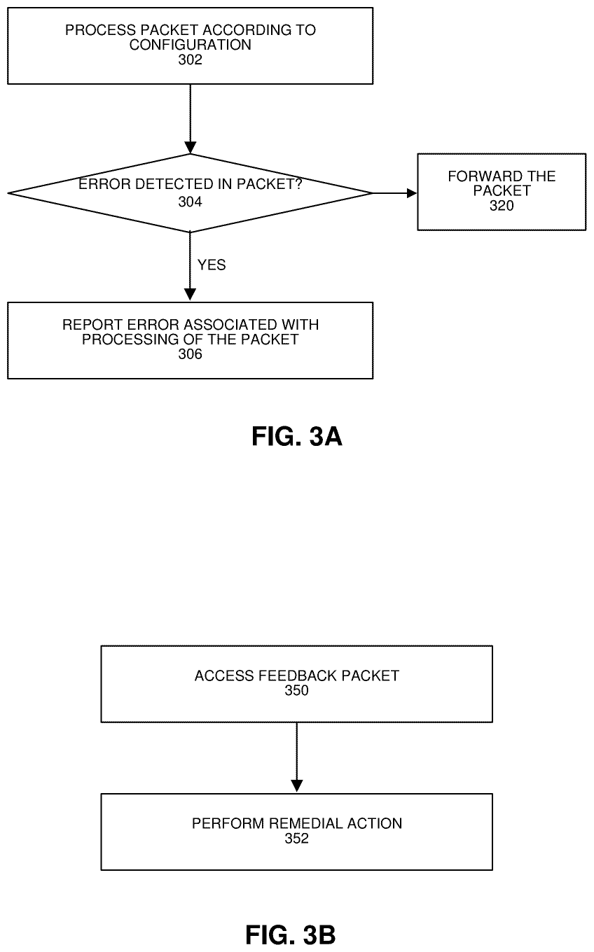

FIG. 3A depicts an example process. The process can be performed by a network interface device and/or host system. Based on receipt of a packet from an ingress port or a packet transmission request, at 302, the network interface device can process the packet. At 304, based on a configuration, the network interface device can determine whether processing of the packet incurs an error. Various examples of errors are described herein. For example, an error can be detected based on processing of a packet header and/or packet payload or with packet processing circuitry independent from the processing of the packet. Based on detection of an error, the process can proceed to 306. Based on no detection of an error, the process can proceed to 320, where the packet can be transmitted to a next destination, dropped according to an applicable rule, or other action.

At 306, the process can record an error indicator and time of error. At 306, the process can issue a feedback packet with the error indicator and time of error for processing by a host system. In some examples, the feedback packet can be stored in a feedback packet queue for access by the host system using access to a packet descriptor. In some examples, the feedback packet can be provided to an ingress port of the network interface device. In some examples, a processor in the network interface device can access the feedback packet.

FIG. 3B depicts an example process. The process can be performed by a network interface device and/or host system. At 350, based on detection of a feedback packet, the process can access the feedback packet. At 352, based on processing of the feedback packet and a configuration, the process can determine a remedial action to perform. Various examples of remedial actions are described herein.

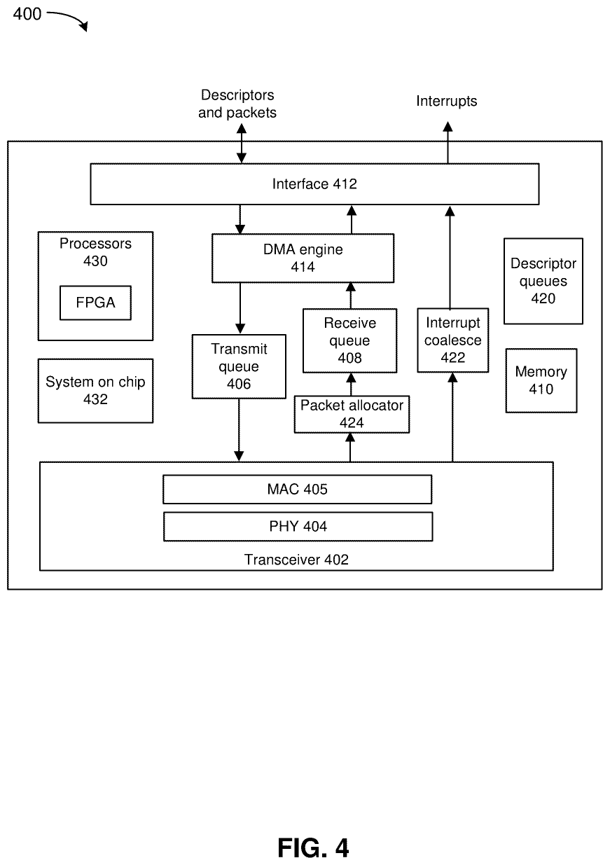

FIG. 4 depicts an example network interface device. In some examples, processors and/or FPGAs 430 can be configured to detect errors with processing packets, as described herein. Some examples of network interface 400 are part of an Infrastructure Processing Unit (IPU) or data processing unit (DPU) or utilized by an IPU or DPU. An xPU can refer at least to an IPU, DPU, graphics processing unit (GPU), general purpose GPU (GPGPU), or other processing units (e.g., accelerator devices). An IPU or DPU can include a network interface with one or more programmable circuitries or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 400 can include transceiver 402, processors 430, transmit queue 406, receive queue 408, memory 410, and host interface 412, and DMA engine 414. Transceiver 402 can be capable of receiving and transmitting packets in conformance with the applicable protocols such as Ethernet as described in IEEE 802.3, although other protocols may be used. Transceiver 402 can receive and transmit packets from and to a network via a network medium (not depicted). Transceiver 402 can include PHY circuitry 404 and media access control (MAC) circuitry 405. PHY circuitry 404 can include encoding and decoding circuitry (not shown) to encode and decode data packets according to applicable physical layer specifications or standards. MAC circuitry 405 can be configured to perform MAC address filtering on received packets, process MAC headers of received packets by verifying data integrity, remove preambles and padding, and provide packet content for processing by higher layers. MAC circuitry 405 can be configured to assemble data to be transmitted into packets, that include destination and source addresses along with network control information and error detection hash values.

Processors 430 can be one or more of: combination of: a processor, core, graphics processing unit (GPU), field programmable gate array (FPGA), application specific integrated circuit (ASIC), or other programmable hardware device that allow programming of network interface 400. For example, a “smart network interface” or SmartNIC can provide packet processing capabilities in the network interface using processors 430.

Processors 430 can include a programmable processing pipeline or offload circuitries that is programmable by P4, Software for Open Networking in the Cloud (SONIC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries. A programmable processing pipeline can include one or more match-action units (MAUs) that are configured based on a programmable pipeline language instruction set. Processors, FPGAs, other specialized processors, controllers, devices, and/or circuits can be utilized for packet processing or packet modification. Ternary content-addressable memory (TCAM) can be used for parallel match-action or look-up operations on packet header content. Processors 430 can be configured to detect and report errors arising from processing a packet, as described herein.

Packet allocator 424 can provide distribution of received packets for processing by multiple CPUs or cores using receive side scaling (RSS). When packet allocator 424 uses RSS, packet allocator 424 can calculate a hash or make another determination based on contents of a received packet to determine which CPU or core is to process a packet.

Interrupt coalesce 422 can perform interrupt moderation whereby interrupt coalesce 422 waits for multiple packets to arrive, or for a time-out to expire, before generating an interrupt to host system to process received packet(s). Receive Segment Coalescing (RSC) can be performed by network interface 400 whereby portions of incoming packets are combined into segments of a packet. Network interface 400 provides this coalesced packet to an application.

Direct memory access (DMA) engine 414 can copy a packet header, packet payload, and/or descriptor directly from host memory to the network interface or vice versa, instead of copying the packet to an intermediate buffer at the host and then using another copy operation from the intermediate buffer to the destination buffer.

Memory 410 can be volatile and/or non-volatile memory device and can store any queue or instructions used to program network interface 400. Transmit traffic manager can schedule transmission of packets from transmit queue 406. Transmit queue 406 can include data or references to data for transmission by network interface. Receive queue 408 can include data or references to data that was received by network interface from a network. Descriptor queues 420 can include descriptors that reference data or packets in transmit queue 406 or receive queue 408. Bus interface 412 can provide an interface with host device (not depicted). For example, bus interface 412 can be compatible with or based at least in part on PCI, PCIe, PCI-x, Serial ATA, and/or USB (although other interconnection standards may be used), or proprietary variations thereof.

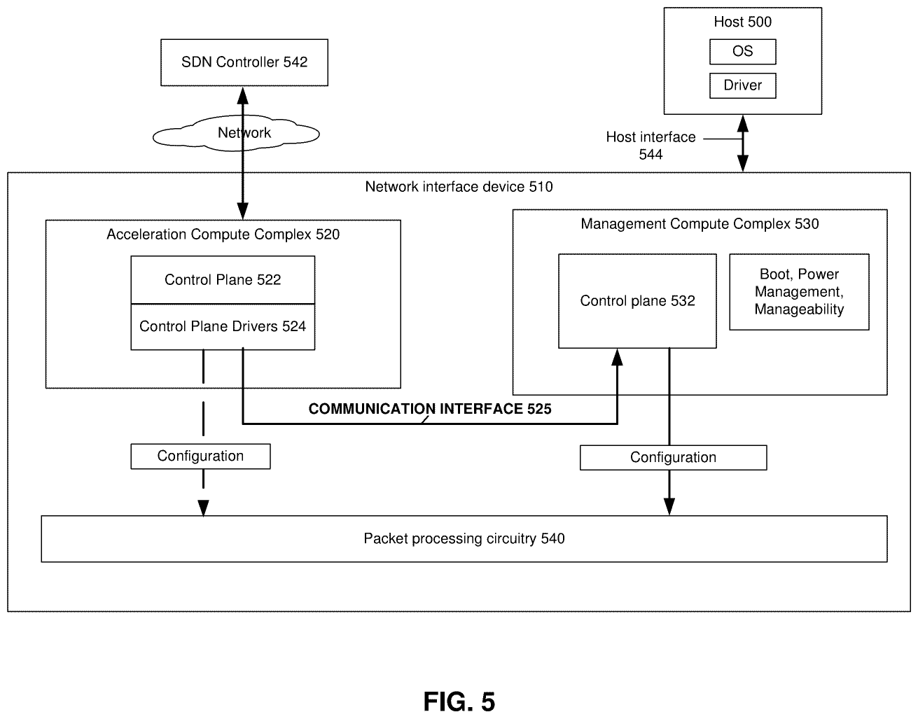

FIG. 5 depicts an example network interface device. Host 500 can include processors, memory devices, device interfaces, as well as other circuitry, such as those described herein. Processors of host 500 can execute software such as applications (e.g., microservices, virtual machine (VMs), microVMs, containers, processes, threads, or other virtualized execution environments), operating system (OS), and device drivers. An OS or device driver can configure network interface device or packet processing device 510 to utilize one or more control planes to communicate with software defined networking (SDN) controller 550 via a network to configure operation of the one or more control planes.

Packet processing device 510 can include multiple compute complexes, such as an Acceleration Compute Complex (ACC) 520 and Management Compute Complex (MCC) 530, as well as packet processing circuitry 540 and network interface technologies for communication with other devices via a network. ACC 520 can be implemented as one or more of: a microprocessor, processor, accelerator, field programmable gate array (FPGA), application specific integrated circuit (ASIC) or circuitry described at least with respect to herein. Similarly, MCC 530 can be implemented as one or more of: a microprocessor, processor, accelerator, field programmable gate array (FPGA), application specific integrated circuit (ASIC) or circuitry described herein. In some examples, ACC 520 and MCC 530 can be implemented as separate cores in a CPU, different cores in different CPUs, different processors in a same integrated circuit, different processors in different integrated circuit.

Packet processing device 510 can be implemented as one or more of: a microprocessor, processor, accelerator, field programmable gate array (FPGA), application specific integrated circuit (ASIC) or circuitry described herein. Packet processing circuitry 540 can process packets as directed or configured by one or more control planes executed by multiple compute complexes. In some examples, ACC 520 and MCC 530 can execute respective control planes 522 and 532.

Packet processing device 510, ACC 520, and/or MCC 530 can be configured to detect and report errors arising from processing packets, as described herein.

SDN controller 542 can upgrade or reconfigure software executing on ACC 520 (e.g., control plane 522 and/or control plane 532) through contents of packets received through packet processing device 510. In some examples, ACC 520 can execute control plane operating system (OS) (e.g., Linux) and/or a control plane application 522 (e.g., user space or kernel modules) used by SDN controller 542 to configure operation of packet processing circuitry 540. Control plane application 522 can incude Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 542 can communicate with ACC 520 using a remote procedure call (RPC) such as Google remote procedure call (gRPC) or other service and ACC 520 can convert the request to target specific protocol buffer (protobuf) request to MCC 530. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 542 can provide packet processing rules for performance by ACC 520. For example, ACC 520 can program table rules (e.g., header field match and corresponding action) applied by packet processing circuitry 540 based on change in policy and changes in VMs, containers, microservices, applications, or other processes. ACC 520 can be configured to provide network policy as flow cache rules into a table to configure operation of packet processing 540. For example, the ACC-executed control plane application 522 can configure rule tables applied by packet processing circuitry 540 with rules to define a traffic destination based on packet type and content. ACC 520 can program table rules (e.g., match-action) into memory accessible to packet processing circuitry 540 based on change in policy and changes in VMs.

For example, ACC 520 can execute a virtual switch such as vSwitch or Open vSwitch (OVS), Stratum, or Vector Packet Processing (VPP) that provides communications between virtual machines executed by host 500 or with other devices connected to a network. For example, ACC 520 can configure packet processing circuitry 540 as to which VM is to receive traffic and what kind of traffic a VM can transmit. For example, packet processing circuitry 540 can execute a virtual switch such as vSwitch or Open vSwitch that provides communications between virtual machines executed by host 500 and packet processing device 510.

MCC 530 can execute a host management control plane, global resource manager, and perform hardware registers configuration. Control plane 532 executed by MCC 530 can perform provisioning and configuration of packet processing circuitry 540. For example, a VM executing on host 500 can utilize packet processing device 510 to receive or transmit packet traffic. MCC 530 can execute boot, power, management, and manageability software (SW) or firmware (FW) code to boot and initialize the packet processing device 510, manage the device power consumption, provide connectivity to Baseboard Management Controller (BMC), and other operations.

One or both control planes of ACC 520 and MCC 530 can define traffic routing table content and network topology applied by packet processing circuitry 540 to select a path of a packet in a network to a next hop or to a destination network-connected device. For example, a VM executing on host 500 can utilize packet processing device 510 to receive or transmit packet traffic.

ACC 520 can execute control plane drivers to communicate with MCC 530. At least to provide a configuration and provisioning interface between control planes 522 and 532, communication interface 525 can provide control-plane-to-control plane communications. Control plane 532 can perform a gatekeeper operation for configuration of shared resources. For example, via communication interface 525, ACC control plane 522 can communicate with control plane 532 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 525 can be utilized by a negotiation protocol and configuration protocol running between ACC control plane 522 and MCC control plane 532. Communication interface 525 can include a general purpose mailbox for different operations performed by packet processing circuitry 540. Examples of operations of packet processing circuitry 540 include issuance of non-volatile memory express (NVMe) reads or writes, issuance of Non-volatile Memory Express over Fabrics (NVMe-oFIM) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 525 can include one or more mailboxes accessible as registers or memory addresses. For communications from control plane 522 to control plane 532, communications can be written to the one or more mailboxes by control plane drivers 524. For communications from control plane 532 to control plane 522, communications can be written to the one or more mailboxes. Communications written to mailboxes can include descriptors which include message opcode, message error, message parameters, and other information. Communications written to mailboxes can include defined format messages that convey data.

Communication interface 525 can provide communications based on writes or reads to particular memory addresses (e.g., dynamic random access memory (DRAM)), registers, other mailbox that is written-to and read-from to pass commands and data. To provide for secure communications between control planes 522 and 532, registers and memory addresses (and memory address translations) for communications can be available only to be written to or read from by control planes 522 and 532 or cloud service provider (CSP) software executing on ACC 520 and device vendor software, embedded software, or firmware executing on MCC 530. Communication interface 525 can support communications between multiple different compute complexes such as from host 500 to MCC 530, host 500 to ACC 520, MCC 530 to ACC 520, baseboard management controller (BMC) to MCC 530, BMC to ACC 520, or BMC to host 500.

Packet processing circuitry 540 can be implemented using one or more of: application specific integrated circuit (ASIC), field programmable gate array (FPGA), processors executing software, or other circuitry. Control plane 522 and/or 532 can configure packet processing circuitry 540 or other processors to perform operations related to NVMe, NVMe-oF reads or writes, lookaside crypto Engine (LCE), Address Translation Engine (ATE), local area network (LAN), compression/decompression, encryption/decryption, or other accelerated operations.

Various message formats can be used to configure ACC 520 or MCC 530. In some examples, a P4 program can be compiled and provided to MCC 530 to configure packet processing circuitry 540.

FIG. 6 depicts a system. In some examples, circuitry of system 600 can configure network interface device 650 to detect and report errors from processing packets, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 632, a system administrator, and/or orchestrator can configure network interface 650 to detect and report errors arising from processing packets, as described herein.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 600 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 600 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more examples and includes an apparatus that includes: a network interface device comprising: a host interface; a direct memory access (DMA) circuitry; a network interface; and circuitry to: based on a configuration, detect an error in an accelerator from processing data associated with a packet received by the network interface; based on detection of the error from processing associated with the data, provide, in-band, a notification via a second packet for delivery to a computing system coupled to the network interface device, wherein the notification is indicative of telemetry associated with the error and a time stamp associated with the error; and based on non-detection of the error from processing the packet, update state associated with a flow of the packet.

Example 2 includes one or more examples, wherein the error comprises telemetry associated with a packet processing pipeline while processing the packet.

Example 3 includes one or more examples, wherein the error is associated with one or more of: framing error, sequence number roll over, overlapping fragments, anti-replay, authentication failure, packet aging violation, or invalid security association (SA).

Example 4 includes one or more examples, wherein the accelerator is to perform operations comprising one or more of: encryption, decryption, data compression, data decompression, authentication, or trust verification.

Example 5 includes one or more examples, wherein the network interface device includes the accelerator.

Example 6 includes one or more examples, wherein the circuitry is to cause the notification to be looped back to an ingress port of the network interface device for delivery by the network interface device via the host interface to the computing system.

Example 7 includes one or more examples, wherein the notification comprises an indicator of the error from processing the packet and a portion of a header of the processed packet and wherein the error from processing the packet is associated with one or more of: framing error, sequence number roll over, overlapping fragments, anti-replay, authentication failure, packet aging violation, or invalid security association (SA).

Example 8 includes one or more examples, wherein the circuitry is to rate limit transmissions of notification packets indicative of errors to the computing system.

Example 9 includes one or more examples, wherein the network interface device comprises one or more of: a network interface controller (NIC), a remote direct memory access (RDMA)-enabled NIC, SmartNIC, router, switch, virtual switch, forwarding element, infrastructure processing unit (IPU), data processing unit (DPU), or edge processing unit (EPU).

Example 10 includes one or more examples, wherein the network interface device comprises second circuitry to perform a remedial action based on the error, wherein the remedial action comprises one or more of: reprogram the network interface device to correctly process the packet associated with the error, disable the network interface device, remove the network interface device from service, limit a traffic rate to the accelerator, change a service level agreement (SLA) parameter associated with the accelerator to remove a packet flow allowed to use the accelerator associated with the error, remove a packet flow from being sent to the accelerator, reprogram the network interface device to drop packets of a flow associated with the error, reset the network interface device, or run diagnostics on the network interface device.

Example 11 includes one or more examples, and includes a method that includes: a network interface device performing: based on a configuration, detecting an error in an accelerator from processing a packet received by the network interface device and based on detection of the error from processing associated with the packet, providing, in-band, a notification via a second packet for delivery to a computing system coupled to the network interface device, wherein the notification is indicative of telemetry associated with the error and a time stamp associated with the error.

Example 12 includes one or more examples, wherein the error is associated with one or more of: framing error, sequence number roll over, overlapping fragments, anti-replay, authentication failure, packet aging violation, or invalid security association (SA).

Example 13 includes one or more examples, wherein the accelerator performs operations comprising one or more of: encryption, decryption, data compression, data decompression, authentication, or trust verification.

Example 14 includes one or more examples, wherein the providing, in-band, a notification via the second packet for delivery to the computing system coupled to the network interface device comprises: storing the second packet in a queue in the network interface device for access by the computing system.

Example 15 includes one or more examples, wherein the notification comprises an indicator of the error from processing the packet and a portion of a header of the processed packet and wherein the error from processing the packet is associated with one or more of: framing error, sequence number roll over, overlapping fragments, anti-replay, authentication failure, packet aging violation, or invalid security association (SA).

Example 16 includes one or more examples, and includes performing a remedial action based on the error, wherein the remedial action comprises one or more of: reprogram the network interface device to correctly process the packet associated with the error, disable the network interface device, remove the network interface device from service, limit a traffic rate to the accelerator, change a service level agreement (SLA) parameter associated with the accelerator to remove a packet flow allowed to use the accelerator associated with the error, remove a packet flow from being sent to the accelerator, reprogram the network interface device to drop packets of a flow associated with the error, reset the network interface device, or run diagnostics on the network interface device.

Example 17 includes one or more examples, and includes at least one non-transitory computer-readable medium comprising instructions stored thereon, that if executed by one or more processors, cause the one or more processors to: execute a driver that is to configure a network interface device to: based on a configuration, detect an error in an accelerator from processing a packet received by the network interface device and based on detection of the error from processing associated with the packet, transmit, in-band, a notification via a second packet for delivery to a computing system coupled to the network interface device, wherein the notification is indicative of telemetry associated with the error and a time stamp associated with the error.

Example 18 includes one or more examples, wherein the error is associated with one or more of: framing error, sequence number roll over, overlapping fragments, anti-replay, authentication failure, packet aging violation, or invalid security association (SA).

Example 19 includes one or more examples, wherein the accelerator performs operations comprising one or more of: encryption, decryption, data compression, data decompression, authentication, or trust verification.

Example 20 includes one or more examples, and includes instructions stored thereon, that if executed by one or more processors, cause the one or more processors to: perform a remedial action based on the error, wherein the remedial action comprises one or more of: reprogram the network interface device to correctly process the packet associated with the error, disable the network interface device, remove the network interface device from service, limit a traffic rate to the accelerator, change a service level agreement (SLA) parameter associated with the accelerator to remove a packet flow allowed to use the accelerator associated with the error, remove a packet flow from being sent to the accelerator, reprogram the network interface device to drop packets of a flow associated with the error, reset the network interface device, or run diagnostics on the network interface device.

1. An apparatus comprising:
a network interface device comprising:
a host interface;
a direct memory access (DMA) circuitry;
a network interface; and
circuitry to:
based on a configuration, detect an error in an accelerator from processing data associated with a packet received by the network interface;
based on detection of the error from processing associated with the data, provide, in-band, a notification via a second packet for delivery to a computing system coupled to the network interface device, wherein the notification is indicative of telemetry associated with the error and a time stamp associated with the error; and
based on non-detection of the error from processing the packet, update state associated with a flow of the packet.

2. The apparatus of claim 1, wherein the error comprises telemetry associated with a packet processing pipeline while processing the packet.

3. The apparatus of claim 1, wherein the error is associated with one or more of: framing error, sequence number roll over, overlapping fragments, anti-replay, authentication failure, packet aging violation, or invalid security association (SA).

4. The apparatus of claim 1, wherein the accelerator is to perform operations comprising one or more of: encryption, decryption, data compression, data decompression, authentication, or trust verification.

5. The apparatus of claim 1, wherein the network interface device includes the accelerator.

6. The apparatus of claim 1, wherein the circuitry is to cause the notification to be looped back to an ingress port of the network interface device for delivery by the network interface device via the host interface to the computing system.

7. The apparatus of claim 1, wherein the notification comprises an indicator of the error from processing the packet and a portion of a header of the processed packet and wherein the error from processing the packet is associated with one or more of: framing error, sequence number roll over, overlapping fragments, anti-replay, authentication failure, packet aging violation, or invalid security association (SA).

8. The apparatus of claim 1, wherein the circuitry is to rate limit transmissions of notification packets indicative of errors to the computing system.

9. The apparatus of claim 1, wherein the network interface device comprises one or more of: a network interface controller (NIC), a remote direct memory access (RDMA)-enabled NIC, SmartNIC, router, switch, virtual switch, forwarding element, infrastructure processing unit (IPU), data processing unit (DPU), or edge processing unit (EPU).

10. The apparatus of claim 1, wherein the network interface device comprises second circuitry to perform a remedial action based on the error, wherein the remedial action comprises one or more of: reprogram the network interface device to correctly process the packet associated with the error, disable the network interface device, remove the network interface device from service, limit a traffic rate to the accelerator, change a service level agreement (SLA) parameter associated with the accelerator to remove a packet flow allowed to use the accelerator associated with the error, remove a packet flow from being sent to the accelerator, reprogram the network interface device to drop packets of a flow associated with the error, reset the network interface device, or run diagnostics on the network interface device.

11. A method comprising:
a network interface device performing:
based on a configuration, detecting an error in an accelerator from processing a packet received by the network interface device and
based on detection of the error from processing associated with the packet, providing, in-band, a notification via a second packet for delivery to a computing system coupled to the network interface device, wherein the notification is indicative of telemetry associated with the error and a time stamp associated with the error.

12. The method of claim 11, wherein the error is associated with one or more of: framing error, sequence number roll over, overlapping fragments, anti-replay, authentication failure, packet aging violation, or invalid security association (SA).

13. The method of claim 11, wherein the accelerator performs operations comprising one or more of: encryption, decryption, data compression, data decompression, authentication, or trust verification.

14. The method of claim 11, wherein the providing, in-band, a notification via the second packet for delivery to the computing system coupled to the network interface device comprises:
storing the second packet in a queue in the network interface device for access by the computing system.

15. The method of claim 11, wherein the notification comprises an indicator of the error from processing the packet and a portion of a header of the processed packet and wherein the error from processing the packet is associated with one or more of: framing error, sequence number roll over, overlapping fragments, anti-replay, authentication failure, packet aging violation, or invalid security association (SA).

16. The method of claim 11, comprising:
performing a remedial action based on the error, wherein the remedial action comprises one or more of: reprogram the network interface device to correctly process the packet associated with the error, disable the network interface device, remove the network interface device from service, limit a traffic rate to the accelerator, change a service level agreement (SLA) parameter associated with the accelerator to remove a packet flow allowed to use the accelerator associated with the error, remove a packet flow from being sent to the accelerator, reprogram the network interface device to drop packets of a flow associated with the error, reset the network interface device, or run diagnostics on the network interface device.

17. At least one non-transitory computer-readable medium comprising instructions stored thereon, that if executed by one or more processors, cause the one or more processors to:
execute a driver that is to configure a network interface device to:
based on a configuration, detect an error in an accelerator from processing a packet received by the network interface device and
based on detection of the error from processing associated with the packet, transmit, in-band, a notification via a second packet for delivery to a computing system coupled to the network interface device, wherein the notification is indicative of telemetry associated with the error and a time stamp associated with the error.

18. The at least one non-transitory computer-readable medium of claim 17, wherein the error is associated with one or more of: framing error, sequence number roll over, overlapping fragments, anti-replay, authentication failure, packet aging violation, or invalid security association (SA).

19. The at least one non-transitory computer-readable medium of claim 17, wherein the accelerator performs operations comprising one or more of: encryption, decryption, data compression, data decompression, authentication, or trust verification.

20. The at least one non-transitory computer-readable medium of claim 17, comprising instructions stored thereon, that if executed by one or more processors, cause the one or more processors to:
perform a remedial action based on the error, wherein the remedial action comprises one or more of: reprogram the network interface device to correctly process the packet associated with the error, disable the network interface device, remove the network interface device from service, limit a traffic rate to the accelerator, change a service level agreement (SLA) parameter associated with the accelerator to remove a packet flow allowed to use the accelerator associated with the error, remove a packet flow from being sent to the accelerator, reprogram the network interface device to drop packets of a flow associated with the error, reset the network interface device, or run diagnostics on the network interface device.
